(19) United States
(12) Patent Application Publication
(10) Pub. No.: US 2012/0165247 A1
(43) Pub. Date: Jun. 28, 2012

(54) USE OF A COMPOSITION FOR TREATMENT AND/OR PROPHYLAXIS OF PLANTS AND RELATIVE COMPOSITION

(76) Inventors: Ilaria Pertot, San Michele all'Adige (IT); Yigal Elad, Bet Dagan (IL)

(21) Appl. No.: 13/389,593

(22) PCT Filed: Aug. 5, 2010
(86) PCT No.: PCT/IB2010/053552

§ 371 Date: Mar. 15, 2012

(30) Foreign Application Priority Data
Aug. 10, 2009 (IT) VR2009A000123

(51) Int. Cl. A01N 37/18; A01P 3/00

(52) U.S. Cl. 514/3.3

(57) ABSTRACT

A method of using a beef extract or a protein hydrolisate or a mixture of beef extract and protein hydrolisate, as active substance, for treatment and/or prophylaxis of plants against the action of pathogens is described. A composition including a beef extract or a protein hydrolisate or a mixture of beef extract and protein hydrolisate, as active substance, for treatment and/or prophylaxis of plants against the action of pathogens is also described.

The present disclosure generally refers to the field of plant health care or defense in agriculture; more specifically, it relates to a treatment and/or prophylaxis of plants against the action of plant pathogens, such as, e.g., bacteria, fungi and the like. In particular, the present disclosure relates to a use of a composition, and relative composition, for treatment and/or prophylaxis of plants against the action of plant pathogens, conventionally also referred to as biostimulant.

Crops and cultivations receive every year high levels of crop protection products (in particular fungicides) in order to guarantee a (quantitatively and qualitatively) sufficient level of production. In particular, foliar diseases can in fact highly affect plants if not adequately treated with fungicides, or other compositions targeted to the treatment of said pathogens.

Currently, one of the most widely used crop protection products is sulphur. An example of sulphur-based commercial product is Thiovit, produced by Syngenta and generally utilized at a concentration of 3 g/l.

A drawback of the use of such a crop protection product is that it is not compatible with the requirements of a sustainable production, as it can cause phytotoxicity on plants, foster phytophage mite pullulation and leave toxic residues on products intended for consumption. Ultimately, a demand has appeared for making available a composition for treatment and/or prophylaxis of plants, which may therefore be used as a safe and effective crop protection product, and concomitantly satisfy the requirements for a sustainable agricultural production.

The article by Crisp P. et al in “An evaluation of biological and abiotic controls for grapevine powdery mildew. Vineyard Trials” AUSTRALIAN JOURNAL OF GRAPE AND WINE RESEARCH, vol. 12, no. 3, 1 Oct. 2006 is also known, which describes results obtained from a treatment by milk and milk serum powder on grapevine leaves. It has been found that the treatment by milk or milk serum allows to obtain a remarkable reduction of fungi on grapevine leaves. Milk or milk serum, though being also comprised of proteins, is not to be deemed as a protein hydrolisate produced by enzymatic digestion and acts as a contact fungicide, i.e. exerts an action that directly kills fungi.

However, also milk and/or milk serum, though advantageous under several standpoints, entail some drawbacks as, e.g., they have been found to reduce plant vigour after their application.

A technical problem at the basis of the present disclosure lies in making available a composition for treatment and/or prophylaxis of plants allowing to overcome said drawbacks related to the known art, and/or attain further advantages.

In particular, the present disclosure relates to the use of beef extract or a protein hydrolisate or a mixture of beef extract and protein hydrolisate, as active substance, for treatment and/or prophylaxis of plants against the action of pathogens.

The present disclosure also relates to a composition including beef extract or a protein hydrolisate or a mixture of beef extract and protein hydrolisate, as active substance, for treatment and/or prophylaxis of plants against the action of pathogens.

Secondary features of the subject-matter of the present disclosure are defined in the respective dependent claims.

In particular, in the present disclosure, the expression “active substance” signifies that beef extract or protein hydrolisate or the mixture of beef extract and protein hydrolisate may also be used alone as illustrated in the following examples 1 to 5, each as active principle or therapeutically active or effective principle, i.e. as a substance per se effective when applied on the plant for defending or protecting the plant from pathogens.

In fact, as illustrated in the following examples, beef extract or protein hydrolisate or the mixture of beef extract and protein hydrolisate, are applied on plants for the intrinsic properties of plant protection and defense.

In practice, beef extract or protein hydrolisate or mixture of beef extract and protein hydrolisate may be used alone, as illustrated in the following examples 1 to 5, and is effective for plant protection and defense from pathogens with results equal to those obtained with the use of a fungicidal substance alone (like sulphur), like e.g. explained in examples 10 to 14.

The expression “beef extract”, also called protein extract, signifies an extract derived from beef and meat infusion (boiling) with no intervention of hydrolytic enzymes.

Moreover, in the present disclosure, the expression “protein hydrolisate”, also called peptone, signifies an enzymatic digestion product formed by a composition including amino acid chains completely bound, or partially bound, or mixed with lipids and obtained after enzymatic digestion of proteins of animal (e.g., casein or albumin) or vegetal (e.g., soy, pea) origin.

The subject-matter of the present disclosure allows to attain several relevant advantages.

An advantage of using said beef extract or said protein hydrolisate or a mixture of said beef extract and said protein hydrolisate is that such products, which are normally used as culture media in microbiology, are usually available to a microbiology technician.

In one embodiment, the composition comprises a mixture of beef extract and protein hydrolisate. This embodiment entails the advantage of combining the efficacy against pathogens of the beef extract and the protein hydrolisate (or peptone) as compared to when they are used individually.

In fact, it has been found that the combination of beef extract and peptone increases the effectiveness with respect to the two products when used individually. Another advantage of the composition according to the present disclosure is that a beef extract or a protein hydrolisate are natural compounds, which can be deemed compatible with requirements foreseen for plant protection defense in an organic and/or sustainable farming.

In one embodiment, the composition is obtained from beef extract, peptone or a mixture thereof, which are dissolved in water.

In one embodiment, the composition is a preparation (i.e., a ready-made preparation) including a mixture of peptone and beef extract; said preparation is conventionally known by the name of “nutrient broth” and is used as microbiology substrate. This preparation is dissolved in water.

In one alternative embodiment, the mixture (or the nutrient broth preparation) includes, in addition to said protein hydrolisate or peptone and the beef extract, also sodium chloride.

The nutrient broth is commercially available, e.g. powder Nutrient Broth marketed by Difco, and including beef extract:peptone in a weight ratio of 3:5, respectively. Another commercially available nutrient broth is Nutrient Broth marketed by Oxoid (with the trade name “Nutrient Broth No. 2”, code CM0067), and including beef extract:peptone:sodium chloride in a weight ratio of 10:10:5, respectively. A composition based on said nutrient broth has at least 13% Nitrogen and 2.2% Amino Nitrogen.

In an embodiment, the composition includes an aqueous solution of beef extract in a concentration between 0.01 and 100 g/l and/or of protein hydrolisate in a concentration between 0.01 and 100 g/l.

A satisfactory effectiveness has been found by using an aqueous solution of 1 g/l beef extract and 1 g/l protein hydrolisate.

In case of use of the above-mentioned nutrient broth having a beef extract:protein hydrolisate ratio of from 1:1 to 3:5 respectively, a composition was found to be active by dissolving in water between 0.08 and 25 g/l preparation; greatest effectiveness was attained at the concentration of 8 g/l preparation.

Such composition is effective in protecting plants from vegetal pathogens and therefore reducing plant diseases. The compound is applied on plants with the same modes of a fungicidal treatment.

For instance, satisfactory results were had in the application on genus Podosphaera, and in particular against Podosphaera aphanis and Podosphaera xanthii, against family Erysiphaceae, more particularly on genus Erysiphe, and in particular against Erysiphe necator, on class Oomycetes, and in particular against Plasmopara viticola.

In particular, the composition according to any one of the above-indicated embodiments induces in the plant a mechanism of resistance against pathogens and, therefore, can be aspecifically active against one or more pathogens. Therefore, with the present disclosure a composition for combating and controlling plant pathogens is made available, wherein such composition may be applied as a normal fungicidal or pesticidal treatment of the mentioned compound, alone or in conjunction with fertilizers or other crop protection products.

In an embodiment, the composition may be used to combat plant pathogens, plants of families Rosaceae, Vitaceae and/or Cucurbitaceae; in particular, a composition according to the present disclosure dissolved in aqueous solution is particularly active against Podosphaera aphanis on strawberry, against Erysiphe necator on grapevine, against Podosphaera xanthii on cucurbits such as cucumber and zucchini.

Moreover, it was found that the composition also has a direct action against spores/conidia of the pathogens and partially inhibits their germination. In particular towards genus Podosphaera, and in particular against Podosphaera aphanis e Podosphaera xanthii, towards family Erysiphaceae, more particularly on genus Erysiphe, and in particular against Erysiphe necator.

The term “plant” is used to denote a vegetal organism and also includes the terms seedling, cutting, bush, tree, rooted vine. The use of the composition according to the present disclosure for a plant health defense against plant pathogens can be of preventive type (prophylaxis) prior to a disease manifestation, as well as of curative type (treatment) after a disease manifestation.

The composition according to any one of the above-indicated embodiments may be used in farming, fruit-growing, horticulture, for post-harvesting treatments of agricultural and food products, on turfgrass and in natural ecosystems. The composition according to any one of the above-indicated embodiments can be applied with a formulation (co-formulants) including the addition of a suitable diluent (as anticipated above, water) and optional coadjuvants, like e.g. substances which are able to modify the properties of an interface (for example, liquid/solid, liquid/air or liquid/liquid interfaces) by lowering the interfacial tension or leading to changes in other properties like e.g. dispersion, emulsification and wetting (dispersing agents, emulsifiers, wetting agents, tackifiers).

The composition according to any one of the above-indicated embodiments can be applied by being added to chemical or biological crop protection products (like, e.g., fungicides, insecticides, acaricides) to increase its effectiveness and spectrum of activity.

Moreover, the composition according to any one of the above-indicated embodiments can be added to fertilizers giving elements nutritional for the plant, such as Nitrogen, Phosphor, Potassium and microelements.

Examples of fungicides which may be added to the composition according to the present disclosure are, e.g., Sulphur, azoxystrobin, penconazole.

Other advantages, features and operation steps of the subject-matter of the present disclosure will be made evident in the following detailed description of embodiments thereof, given by way of example and not for limitative purposes.

However, it is evident how each embodiment example may entail one or more of the advantages listed above; in any case, however, it is not required for each embodiment example to concomitantly entail all of the advantages listed.

In particular, with reference to the annexed figures:

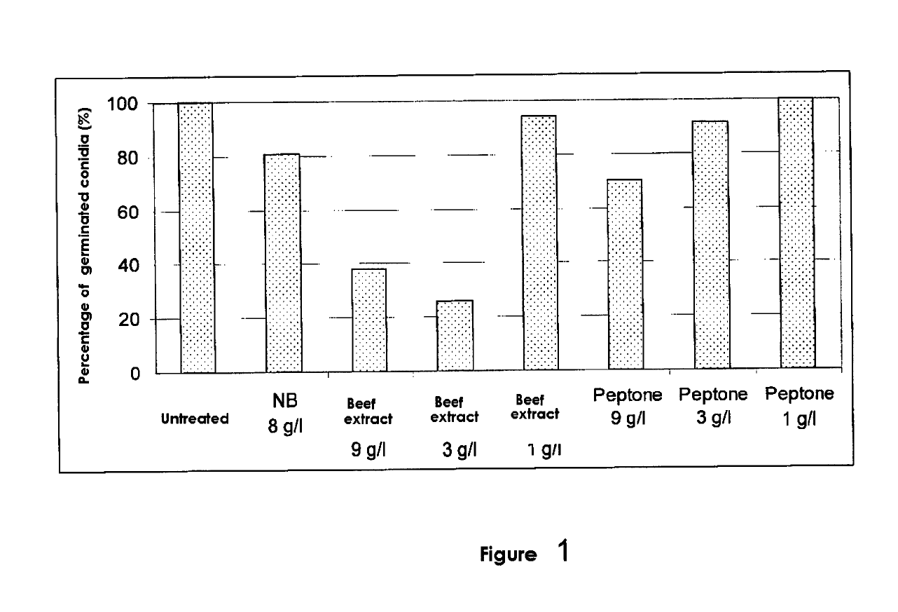

FIG. 1 shows an effect of the treatment with some compositions according to the present disclosure on germination of Podosphaera xanthii conidia on a glass slide;

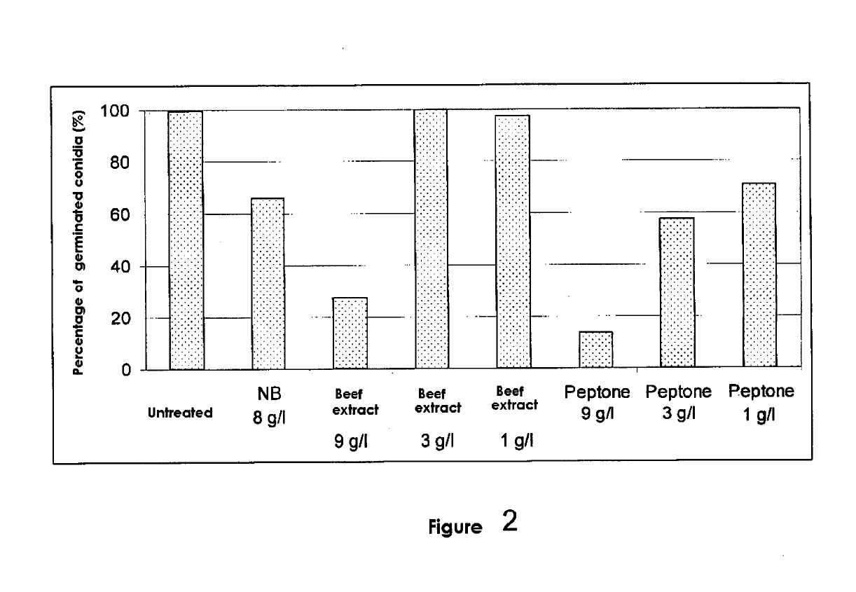

FIG. 2 shows an effect of the treatment with some compositions according to the present disclosure on the germination of Podosphaera xanthii conidia on cucumber leaves;

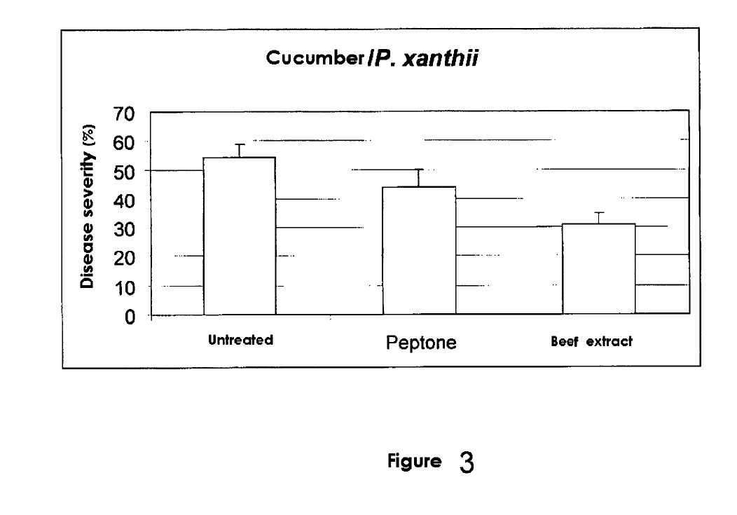

FIG. 3 shows an effect of the treatment with the composition according to the present disclosure on the severity of Podosphaera aphanis on cucumber;

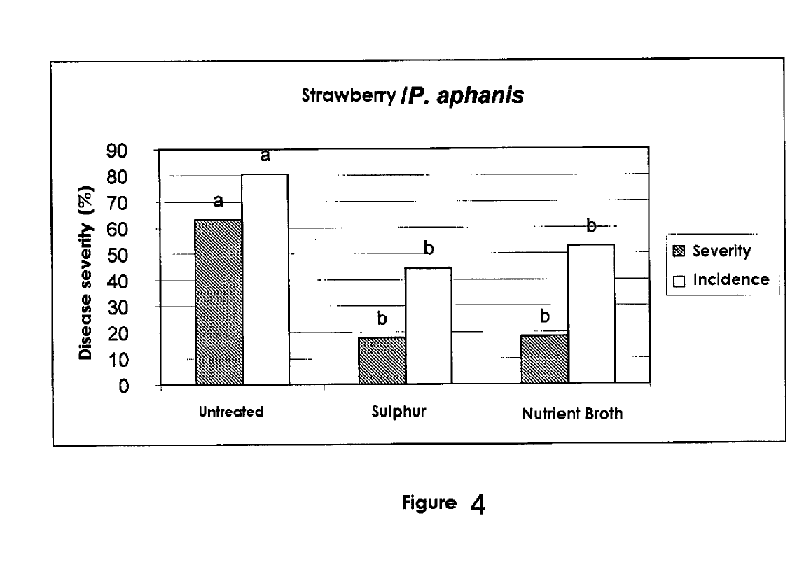

FIG. 4 shows an effect of the treatment with a composition according to the present disclosure on the incidence and severity of Podosphaera aphanis on strawberry leaves;

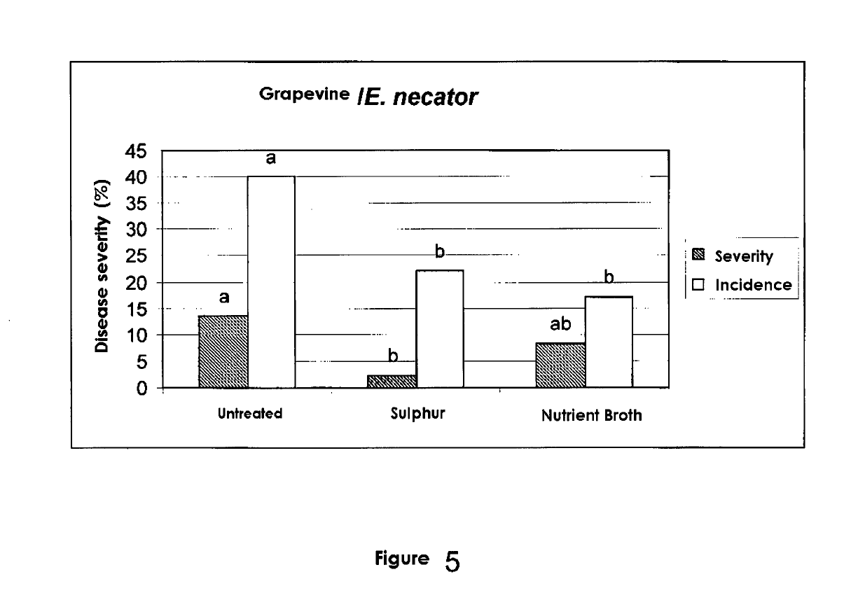

FIG. 5 shows an effect of the treatment with a composition according to the present disclosure on the incidence and severity of Erysiphe necator on grapevine leaves;

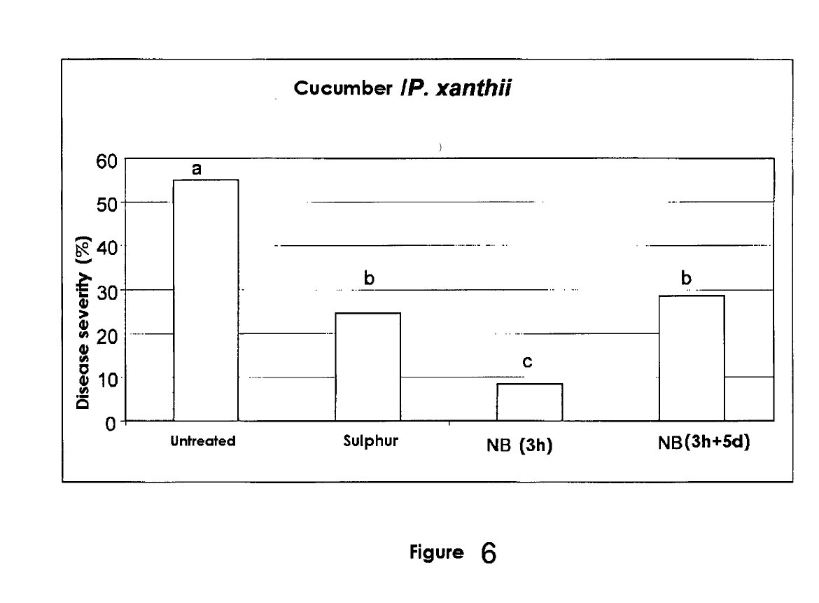

FIG. 6 shows an effect of the treatment with a composition according to the present disclosure on the severity of Podosphaera xanthii on cucumber leaves;

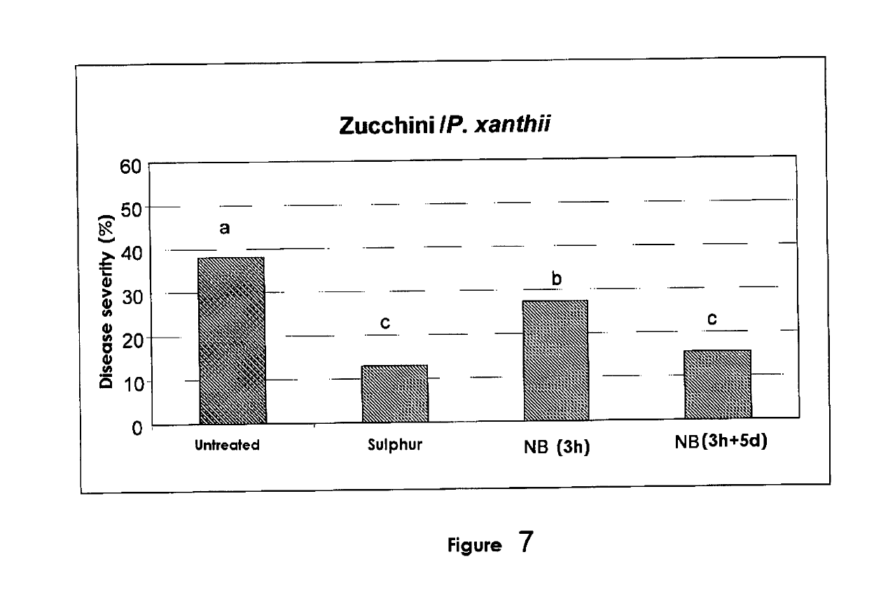

FIG. 7 shows an effect of the treatment with a composition according to the present disclosure on the severity of Podosphaera xanthii on zucchini leaves;

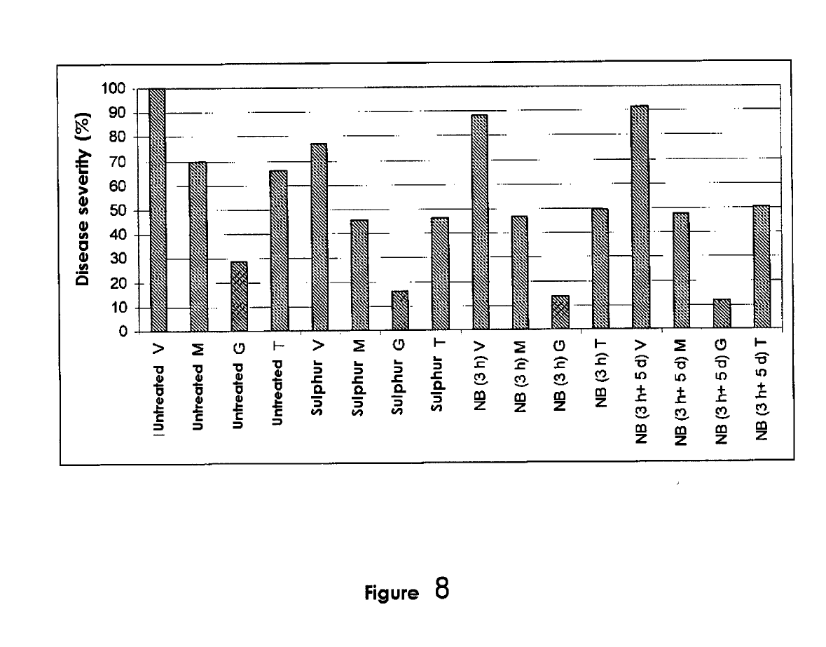

FIG. 8 shows an effect of the treatment with a composition according to the present disclosure on the severity of Podosphaera xanthii on cucumber leaves, in which in particular older leaves (V) middle leaves (M) and younger leaves (G) were separately evaluated;

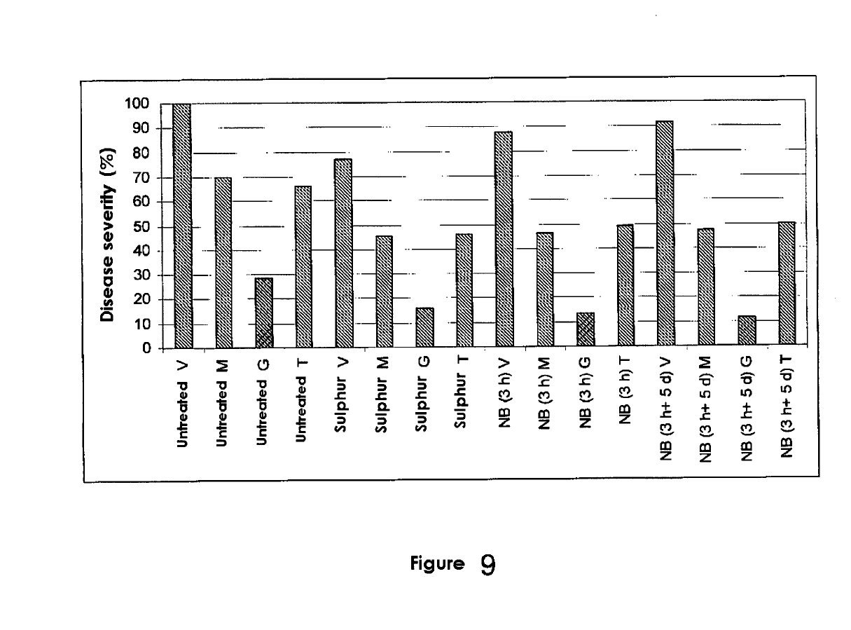

FIG. 9 shows an effect of the treatment with a composition according to the present disclosure on the severity of Podosphaera xanthii on zucchini leaves, in which in particular older leaves (V) middle leaves (M) and younger leaves (G) were separately evaluated;

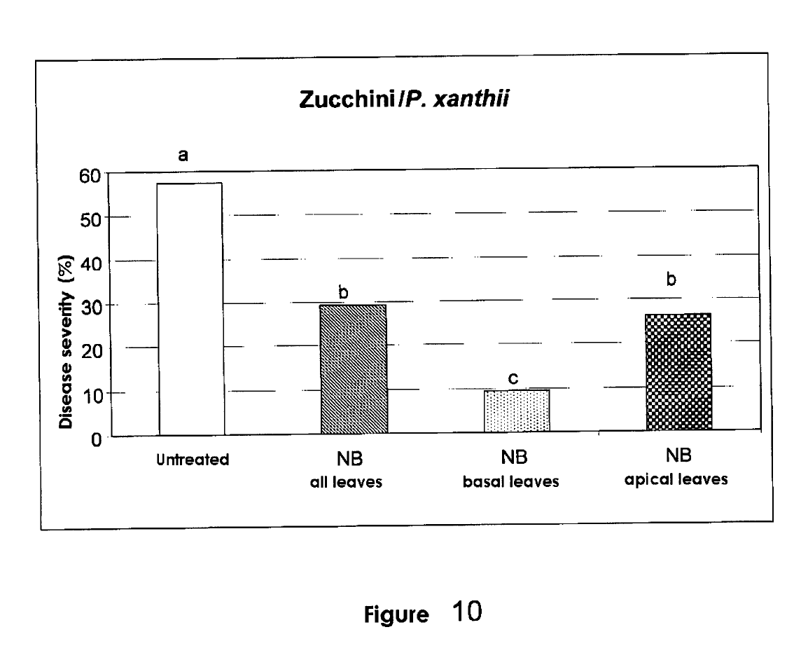

FIG. 10 shows an effect of the treatment with a composition according to the present disclosure on the severity of Podosphaera xanthii on zucchini leaves.

Referring to the following examples 1 to 6, a process for preparing a composition according to the present disclosure for treatment of plants is described.

### EXAMPLE 1

3 g powdered beef extract are diluted in 1 litre of water at room temperature.

The obtained aqueous solution is a composition suitable for treatment of plants according to the present disclosure.

### EXAMPLE 2

5 g powdered peptone or protein hydrolisate are diluted in 1 litre of water at room temperature.

The obtained aqueous solution is a composition suitable for treatment of plants according to the present disclosure.

### EXAMPLE 3

1 g powdered peptone is diluted in 1 litre of water at room temperature. The obtained aqueous solution is a composition suitable for treatment of plants according to the present disclosure.

### EXAMPLE 4

1 g beef extract and 1 g peptone are diluted in 1 litre of water at room temperature. The obtained aqueous solution is a composition suitable for treatment of plants according to the present disclosure.

### EXAMPLE 5

8 g of a powder preparation containing a beef extract and peptone in a ratio of 3:5 and commonly referred to as “nutrient broth” on the market are dissolved in 1 litre of water at room temperature.

### EXAMPLE 6

A composition prepared according to any one of the above-indicated examples 1 to 5 is admixed with

co-formulants, like e.g. surfactants, i.e. substances which, in order to improve on-plant application, are able to modify the properties of an interface of the components of the composition (e.g., a liquid/solid, liquid/air or liquid/liquid interface) by lowering the interfacial tension or leading to changes in other properties like e.g. dispersion, emulsification and wetting (dispersing agents, emulsifiers, wetting agents, tackifiers);

chemical or biological crop protection products (like, e.g., fungicides, insecticides, acaricides to improve their effectiveness and spectrum of activity);

fertilizers, giving elements nutrient for the plant, such as Nitrogen, Phosphor, Potassium and microelements.

Examples of fungicides which may be added to the composition according to the present disclosure are, e.g., Sulphur, azoxystrobin, penconazole. Admixing may be carried out both under dry conditions before in-water dilution and as addition to the aqueous solution.

### EXAMPLE 7

In the present example an application of a composition made according to any one of examples 1 to 6 is described.

In particular, an application according to the present disclosure provides that plants or parts thereof be sprayed with the solution or dipped in the solution.

The treatment may be applied preventively, a single time or repeated at time intervals, e.g. every 3 days, both preventively (prophylaxis prior to a disease manifestation) and curatively (treatment after a disease manifestation by the pathogen).

### EXAMPLE 8

In the present example the properties of a composition according to the present disclosure towards spores/conidia of plant pathogens are described.

In particular, an inhibition of a germination of Podosphaera aphanis conidia or Podosphaera xanthii conidia, both in vitro (on a glass slide) and on leaf (strawberry or cucumber) is described.

Optical microscopy glass slides or cucumber leaves were uniformly sprayed with a solution according to any one of the examples 1 to 6, in particular examples 1, 2 and 5.

5 samples (replicates) were prepared for each experimental unit (leaves and glass slides, treated and untreated). The solution was left to dry (about 1 hour). Then, conidia were applied, letting them fall by gravity. In particular, infected cucumber leaves with consistent sporulations were shaken above the glass slides or treated leaves. Glass slides and leaves were incubated for 24-48 hours at 20-25° C. and high relative humidity (99%). Germinated conidia were counted with an optical microscope after having stained the samples with Cotton blue.

Results obtained with respect to Podosphaera xanthii on glass slide and cucumber leaf with the two components (beef extract and peptone) individually and admixed (nutrient broth) are shown in FIG. 1 and FIG. 2.

In particular, FIG. 1 shows an effect of the treatment with a composition according to the present disclosure; specifically, as mentioned, an effect of the solution described in the above-mentioned example 5, i.e. nutrient broth (denoted by “NB” in the figures), and components (beef extract and peptone) thereof on the germination of Podosphaera xanthii conidia on glass slide, in which the values represent a mean of three replicates per experimental unit. It has to be noted that nutrient broth, beef extract and peptone reduce conidia germination as compared to an untreated sample.

FIG. 2 shows an effect of the treatment with a composition according to the present disclosure, in particular, as mentioned, the solution described in the above-mentioned example 5, i.e. nutrient broth (denoted by “NB” in the figures), and its components (beef extract and peptone) on the germination of Podosphaera xanthii conidia on cucumber leaf, in which the values represent a mean of three replicates per experimental unit. It has to be noted that nutrient broth, beef extract and peptone reduce conidia germination as compared to an untreated sample.

Results obtained with the compound (nutrient broth) with regard to Podosphaera aphanis on glass slide and strawberry leaf are shown in Table 1 herebelow.

TABLE 1

Germinated conidia (%)

| | Leaves | Glass slides |
|---|---|---|
| Nutrient broth | 0 | 0 |
| Untreated | 10 | 13 |

In particular, in Table 1 a percentage of Podosphaera aphanis conidia germinated on glass slide or strawberry leaf treated with the composition according to example 5 reported above (nutrient broth, 8 g/l) is indicated, as compared to untreated conidia on glass slide and leaf. Reported values represent a means of 5 replicates per each experimental unit.

### EXAMPLES 9-15

In the following examples there are described the protection and defense properties of some compositions according to the present disclosure, in particular according to some of the examples 1, 2 and 5, against some plant diseases. Specifically, examples 9 to 15 describe a treatment against Erysiphe necator on grapevine, against Podosphaera aphanis on strawberry and against Podosphaera xanthii on two cucurbits (cucumber and zucchini).

Even more specifically, in examples 9 to 15 the plants were inoculated using a technique envisaging the shaking of infected leaves, respectively of grapevine, strawberry, zucchini and cucumber, collected under natural conditions and infected with the various pathogens, so as to have pathogen conidia (spores) fall uniformly on healthy plants.

In the case of the grapevine/E. necator system, plants of highly susceptible cultivars (Pinot gris) having 2 shoots and at least 4 expanded leaves (greater than 10 cm²) were used.

In the case of the strawberry/P. aphanis system, plants of cultivar Elsanta, having 4-5 developed leaves were used.

In the case of zucchini and cucumber with P. xanthii, respectively plants of cv. Xara and 807 with at least 4 developed leaves were used.

Treatments were applied just before inoculation (no more than 3 hours) and before inoculation on strawberry and grapevine, and 5 days before and just before inoculation for cucumber and zucchini.

Sulphur (Thiovit, Syngenta, 3 g/l) and water were used respectively as reference standard and untreated control.

Compositions according to the present disclosure were sprayed by means of an air compressor system operating at a pressure of 4 bar.

After treatment application and inoculation, the plants were incubated under high humidity conditions (95-98%) for 24 hours at 20-25° C. Then, they were kept in a greenhouse under a controlled-temperature environment (20-25° C.) until appearance of symptoms.

Depending on the system considered, the time period between inoculation and symptom assessment varied from 15 to 30 days. In each plant/pathogen system, symptom assessment was carried out after the same time period for the plants treated with the composition according to the present disclosure, the reference standard and the untreated plants.

Disease was evaluated as incidence (percentage of infected leaves) and/or severity (percentage of leaf area infected). In the case of zucchini and cucumber, see examples 13 and 14, a distinction was also drawn among older leaves (1 layer), middle leaves (2 layer) and younger leaves (3 layer).

The experimental design was carried out in fully randomized blocks with at least 3-5 replicates (3-6 plants) per experimental unit. The term “randomized block” signifies that 5 groups of plants are disposed at random in a greenhouse, in order to minimize the influence of environmental conditions on each individual group subjected to treatment.

Values were calculated as average values per replicate. Analysis of variance (ANOVA) was applied on transformed data (arcsin). Means were separated using Fisher's test. The statistical program used was Statistica, version 8, Statsoft INC. Experiments were repeated and results of the two experiments were united.

### EXAMPLE 9

A composition prepared according to example 1 and a composition prepared according to example 2 were used on cucumber/P. xanthii.

Results related to the composition prepared according to example 1 and to the composition prepared according to example 2 on cucumber/P. xanthii are reported in FIG. 3. In particular, FIG. 3 shows a severity value of P. aphanis on cucumber leaves. Treatments with beef extract (example 1) and peptone (example 2) were applied 3 hours before inoculation. Disease assessment was carried out 14 days after inoculation. Results are the average of 4 replicates of 6 plants each. Error bar represents the standard deviation.

The composition prepared according to example 1 and the composition prepared according to example 2, including respectively beef extract and peptone, is active against the disease. Beef extract is more active than peptone.

### EXAMPLE 10

A composition prepared according to example 5 (nutrient broth) was used at a concentration of 8 g/l, and applied on Strawberry/P. aphanis. The results of this application are reported in FIG. 4.

In particular, FIG. 4 shows a severity value and incidence of P. aphanis on strawberry leaves. Treatments were applied 3 hours before inoculation. Disease assessment was carried out 14 days after inoculation. Results are the average of 4 replicates of 6 plants each. Different letters indicate significant differences according to Fisher's test at P≦0.05.

The composition prepared according to example 5 (nutrient broth) is effective against the disease as the fungicidal treatment (sulphur).

### EXAMPLE 11

A composition prepared according to example 5 (nutrient broth) was used at a concentration of 8 g/l, and was applied on grapevine/E. necator. The results of this application are reported in FIG. 5.

In particular, FIG. 5 shows a severity value and incidence of E. necator on grapevine leaves. Treatments were applied 3 hours before inoculation. Disease assessment was carried out 14 days after inoculation. Results are the average of 5 replicates of 3 plants each. Different letters indicate significant differences according to Fisher's test at P≦0.05.

The composition prepared according to example 5 (nutrient broth) is effective against the disease as the fungicidal treatment (sulphur).

### EXAMPLE 12

A composition prepared according to example 5 (nutrient broth) was used at a concentration of 8 g/l, and applied on cucumber/P. xanthii. The results of single and repeated applications of this composition are reported in FIG. 6.

In particular, FIG. 6 shows an incidence value of P. xanthii on cucumber leaves. Treatments with nutrient broth (NB) were applied once 3 hours before inoculation and repeated twice (5 days and 3 hours before inoculation). Disease assessment was carried out 14 days after inoculation. Results are the average of 5 replicates of 5 plants each. Different letters indicate significant differences according to Fisher's test at P≦0.05.

The composition prepared according to example 5 (nutrient broth) is effective against the disease as the fungicidal treatment (sulphur).

### EXAMPLE 13

A composition prepared according to example 5 (nutrient broth) was used at a concentration of 8 g/l, and applied on zucchini/P. xanthii.

The results of single and repeated applications of this composition are reported in FIG. 7.

In particular, FIG. 7 shows a severity value and incidence of P. xanthii on zucchini leaves. Treatments with nutrient broth (NB) were applied once (3 hours before inoculation) and repeated twice (5 days and 3 hours before inoculation). Disease assessment was carried out 14 days after inoculation. Results are the average of 5 replicates of 5 plants each. Different letters indicate significant differences according to Fisher's test at P≦1.05.

The composition prepared according to example 5 (nutrient broth) is effective against the disease as the fungicidal treatment (sulphur).

### EXAMPLE 14

A composition prepared according to example 5 (nutrient broth) was used at a concentration of 8 g/l, and was applied on cucumber/P. xanthii, in particular on leaves of different ages.

The results of single and repeated applications of this composition on leaves of different ages are reported in FIG. 8.

In particular, FIG. 8 shows a severity value and incidence of P. xanthii on cucumber leaves. Treatments with nutrient broth (NB) were applied once 3 hours before inoculation (denoted by “3 h” in FIG. 8) and repeated twice (5 days and 3 hours before inoculation, denoted by “3h+5d” in FIG. 8). Disease assessment was carried out 14 days after inoculation. Older leaves (V), middle leaves (M) and younger leaves (G) were evaluated separately. Evaluation of all leaves is also reported. Results are the average of 5 replicates of 5 plants each. Different letters indicate significant differences according to Fisher's test at P≦0.05.

The composition prepared according to example 5 (nutrient broth) is effective against the disease as the fungicidal treatment (sulphur) on leaves of all ages.

### EXAMPLE 15

A composition prepared according to example 5 (nutrient broth) was used at a concentration of 8 g/l, and was applied on zucchini/P. xanthii in particular on leaves of different ages. The results of single and repeated applications of this composition on leaves of different ages are reported in FIG. 9.

In particular, FIG. 9 shows a severity value and incidence of P. xanthii on zucchini leaves. Treatments with nutrient broth (NB) were applied once, 3 hours before inoculation (denoted by “3 h” in FIG. 9) and repeated twice (5 days and 3 hours before inoculation, denoted by “3h+5d” in FIG. 9). Disease assessment was carried out 14 days after inoculation. Older leaves (V), middle leaves (M) and younger leaves (G) were evaluated separately. Evaluation of all leaves is also reported. Results are the average of 5 replicates of 5 plants each. Different letters indicate significant differences according to Fisher's test at P≦0.05.

The composition prepared according to example 5 (nutrient broth) is effective against the disease as the fungicidal treatment (sulphur) on leaves of all ages.

### EXAMPLE 16

The present example describes a mechanism of action for a composition according to the present disclosure, i.e. the activation, generated by the composition, of a mechanism of resistance induced in plants against pathogens.

By way of example, as plant zucchini and, as pathogen, P. xanthii were selected. The plants were inoculated by a technique envisaging the shaking of infected leaves, respectively of zucchini, collected under natural conditions and infected with the pathogen, so as to have pathogen conidia (spores) fall uniformly on healthy plants.

A composition prepared according to example 5 (nutrient broth) was used at a concentration of 8 g/l, and was applied on zucchini. Sulphur (Thiovit, Syngenta, 3 g/l) and water were used respectively as reference standard and untreated control. The composition prepared according to example 5 (nutrient broth), the reference standard and the untreated control were sprayed by means of an air compressor system operating at a pressure of 4 bar. Respectively, plants of cv. Xara with at least 8 developed leaves were used.

Treatments were applied just before inoculation (no more than 3 hours) only on basal leaves or on the basal surface of each leaf.

After treatment application and inoculation, the plants were incubated under high humidity conditions (95-98%) for 24 hours at 20-25° C. Then, they were kept in a greenhouse under a controlled-temperature environment (20-25° C.) until appearance of symptoms.

According to the system considered, the time period between inoculation and symptom assessment varied from 15 to 30 days. Symptom assessment was carried out after the same time period for the plants treated with the compound, the reference standard and the untreated plants.

The disease was assessed as severity (percentage of leaf area infected).

The experimental design was carried out in completely randomized blocks as indicated above, with at least 5 replicates (3-5 plants) per experimental unit. Values were calculated as average values per replicate. Analysis of variance (ANOVA) was applied on transformed data (arcsin). Averages were separated using Tukey's or Fisher's test. The statistical program used was Statistica, version 8, Statsoft INC. The experiments were repeated and results of the two tests were united.

The results related to nutrient broth on zucchini/P. xanthii with applications on basal leaves and on the whole plant are reported in FIG. 10.

When applied only on basal leaves of the plant, the nutrient broth is as effective on treated (basal) leaves, and also on untreated (apical) leaves, as a treatment carried out on all leaves.

Severity and incidence of P. xanthii on zucchini leaves are shown in FIG. 10. Nutrient broth (NB) treatments were applied on the whole plant (3 hours before inoculation) or only on basal leaves. Disease assessment was carried out 14 days after inoculation. Results are the average of 5 replicates of 5 plants each. Different letters indicate significant differences according to Fisher's test at P≦0.05.

Even more specifically, the white column corresponds to the disease on untreated plants, the hatched column corresponds to the disease on plants with all leaves treated, the dotted column corresponds to the disease on (basal) leaves of treated plants where only basal leaves were treated, the checkered column corresponds to the disease on untreated (apical) leaves on plants where only basal leaves were treated.

Since the disease reduction effect is also transferred on untreated leaves of a plant, it can be deemed that besides a direct effect on spore germination there is also the triggering of a phenomenon of resistance induced in the plant against the disease. The subject-matter of the present disclosure has been hereto described with reference to embodiments thereof. It is understood that other embodiments might exist, all falling within the concept of the same invention, and all comprised within the protective scope of the claims hereinafter.

1. Use of a beef extract or a protein hydrolisate or a mixture of beef extract and protein hydrolisate, as active substance, for treatment and/or prophylaxis of plants against the action of pathogens.

2. Use according to claim 1, wherein said active substance induces, in a plant, a mechanism of resistance against plant pathogens.

3. Use according to claim 1 or 2, wherein said protein hydrolisate is a composition obtained by enzymatic digestion of proteins.

4. Use according to any one of claims 1 to 3, wherein said protein hydrolisate is a composition obtained by enzymatic digestion of proteins of vegetal origin.

5. Use according to any one of the preceding claims, wherein said mixture of beef extract and protein hydrolisate is a powder preparation called nutrient broth.

6. Use according to any one of the preceding claims, wherein, in said mixture of beef extract and protein hydrolisate, beef extract and protein hydrolisate are in a weight ratio of 3:5 respectively.

7. Use according to any one of the preceding claims, wherein, in said mixture of beef extract and protein hydrolisate, beef extract and protein hydrolisate are in a weight ratio of 1:1 respectively.

8. Use according to any one of the preceding claims, wherein said beef extract o protein hydrolisate or mixture of beef extract and protein hydrolisate are dissolved in water.

9. Use according to claim 8, including 0.01 to 100 g/l beef extract and/or 0.01 to 100 g/l protein hydrolisate in water.

10. Use according to claim 8, including 1 g/l beef extract and/or 1 g/l protein hydrolisate in water.

11. Use according to claim 8, 9 or 10, comprising 0.08 to 25 g/1 mixture of beef extract and protein hydrolisate in water.

12. Use according to claim 8, 9 or 10, comprising 8 g/l mixture of beef extract and protein hydrolisate in water.

13. Use according to any one of the preceding claims, wherein said pathogens include pathogens of genus Podosphaera, of genus Erysiphe, of class Oomycetes, of family Erysiphaceae.

14. Use according to claim 13, wherein said pathogens include Podosphaera aphanis, Podosphaera xanthii, Plasmopara viticola, Erysiphe necator.

15. Use according to any one of the preceding claims, wherein said plants include plants of the families Rosaceae, Vitaceae, Cucurbitaceae.

16. Use according to any one of the preceding claims, wherein, to beef extract or protein hydrolisate or mixture of beef extract and protein hydrolisate, it is further added a compound selected from the group: surfactants, dispersing agents, emulsifiers, wetting agents, tackifiers or a mixture thereof.

17. Use according to any one of claims 1 to 16, wherein said beef extract, protein hydrolisate or mixture of beef extract and protein hydrolisate are applied prior to a disease manifestation.

18. Use according to any one of claims 1 to 16, wherein said beef extract, protein hydrolisate or mixture of beef extract and protein hydrolisate are applied after a disease manifestation.

19. A composition for treatment and/or prophylaxis of plants against the action of pathogens, said composition including, as active substance, a beef extract or a protein hydrolisate or a mixture of beef extract and protein hydrolisate.

20. The composition according to claim 19, wherein said composition is a beef extract.

21. The composition according to claim 19, wherein said composition is a protein hydrolisate.

22. The composition according to claim 19, wherein said composition is a mixture of beef extract and protein hydrolisate

23. The composition according to claim 19 or 22, wherein said mixture of beef extract and protein hydrolisate is a powder preparation called nutrient broth.

24. The composition according to claim 19 or 22, wherein, in said mixture of beef extract and protein hydrolisate, said beef extract and protein hydrolisate are in a weight ratio of 3:5, respectively.

25. The composition according to claim 19 or 22, wherein, in said mixture of beef extract and protein hydrolisate, said beef extract and protein hydrolisate are in a weight ratio of 1:1, respectively.

26. The composition according to any one of the preceding claims 19 to 25, wherein said beef extract or protein hydrolisate or mixture of beef extract and protein hydrolisate are dissolved in water.

27. The composition according to claim 26, including 0.01 to 100 g/l beef extract and/or 0.01 to 100 g/l protein hydrolisate in water.

28. The composition according to claim 27, including 1 g/l beef extract and/or 1 g/l protein hydrolisate in water.

29. The composition according to claim 28, comprising 0.08 to 25 g/l mixture of beef extract and protein hydrolisate in water.

30. The composition according to any one of claims 19 to 29, wherein, to said beef extract or protein hydrolisate or mixture of beef extract and protein hydrolisate, it is further added a compound selected from the group: surfactants, dispersing agents, emulsifiers, wetting agents, tackifiers, or a mixture thereof.

31. Inducer of resistance, in a plant, against plant pathogens, including any one composition according to any one of claims 19 to 30.
